(19) United States
(12) Patent Application Publication
(10) Pub. No.: US 2002/0160636 A1
(43) Pub. Date: Oct. 31, 2002

(54) Plug-in power supply with miniaturized primary contact means

(75) Inventors: Thomas Steiert, Ostbevern (DE); Andreas Kniesel, Muenster (DE)

Correspondence Address: MICHAEL BEST & FRIEDRICH, LLP, 100 E WISCONSIN AVENUE, MILWAUKEE, WI, 53202, US

(73) Assignee: Friwo Geraetebau GmbH, Ostbevern (DE)

(21) Appl. No.: 10/051,437

(22) Filed: Jan. 18, 2002

(30) Foreign Application Priority Data
Jan. 22, 2001 (DE) 101 02 713.3

(51) Int. Cl. H01R 13/44; H01R 13/60

(52) U.S. Cl. 439/131

(57) ABSTRACT

A plug-in power supply for converting a mains voltage into an operating voltage is provided, comprising a housing having arranged therein an electronic circuit for voltage conversion, and at least two primary contact pins which are movable between an operating position, in which they are adapted to be inserted into the mains socket and in which they extend substantially at right angles to one of the lateral surfaces of the housing, and a position of rest on at least one of said lateral surfaces, the primary contact pins being arranged substantially parallel to said at least one lateral surface in said position of rest. In order to achieve the largest possible reduction of size and in order to guarantee that the plug-in power supply can be handled easily and safely, a geometric arrangement of the primary contact pins with respect to each other in their position of rest differs from a geometric arrangement of the primary contact pins in their operating position.

### BACKGROUND OF THE INVENTION

1. Field of the Invention

The present invention generally relates to DC power supplies and in particular to a plug-in power supply for converting a mains voltage into an operating voltage, comprising a housing having arranged therein an electronic circuit for voltage conversion, and at least two primary contact pins which are movable between an operating position, in which they are adapted to be inserted into the mains socket and in which they extend substantially at right angles to one of the lateral surfaces of the housing, and a position of rest on at least one of said lateral surfaces, the primary contact pins being arranged substantially parallel to said at least one lateral surface in said position of rest.

2. Description of the Related Art

As outlined in FIG. 1, conventional plug-in power supplies, which convert the mains voltage (normally 110 or 230 volt) into an operating voltage (normally a so-called extra-low safety voltage), comprise a housing 102 having essentially the shape of a rectangular parallelepiped and including a cover surface 110, a base surface 111 as well as four lateral surfaces 116. The housing 102 has arranged therein an electronic circuit for voltage conversion. In addition, the plug-in power supply 100 is normally provided with an electric connecting line 104 which is adapted to be inserted via a plug into a plug socket of a load, and a primary contact 108 arranged on the base surface 111 and adapted to be inserted into a mains socket. The trend towards size optimization of mobile loads, such as mobile phones, palm-tops or the like, makes it necessary that also the accessories required, such as a charging set, which can be realized in the form of a plug-in power supply according to FIG. 1, are miniaturized to the greatest degree possible. In particular on the Asian market, a volume optimization of technical devices is a feature which decisively influences the buyer's decision. The reduction of size is limited by the electric components which have to be used and by the standards which have to be observed with regard to insulation distances and creeping distances. It follows that narrow limits are set to a more far-reaching miniaturization of the plug-in power supply, especially in the operating condition, as can be seen for instance from DE 198 35 161 C1 and DE 198 45 962 C1.

Since a reduction of the size of the plug-in power supply is important especially for the purpose of transporting the same, suggestions have been made that, for transporting the plug-in power supply, the primary contact pins 108 should be moved to a position of rest either by swiveling them onto the base surface 111 in direction 109A or by moving them into the housing 102 in direction 109B.

Such conventional plug-in power supplies are known for instance from DE 297 08 598 U1 and U.S. Pat. No. 5,901,056.

For accommodating the primary contact pins 108 on the base surface 111, a recess is provided, which extends comparatively far into the interior of the housing. This has the effect that the volume in the housing interior that can be used for the electric components is reduced by mechanical components.

A further drawback of the arrangement outlined in FIG. 1 is the disadvantageous position of the plug-in power supply 100 in a mains socket in which neighboring sockets may be covered.

### SUMMARY OF THE INVENTION

It is therefore the object of the present invention to provide a plug-in power supply for converting a mains voltage into an operating voltage, said plug-in power supply being reduced still further in size and adapted to be handled easily and safely.

According to one embodiment, a geometric arrangement of the primary contact pins with respect to each other in their position of rest differs from a geometric arrangement of the primary contact pins in their operating position.

A substantial advantage of said plug-in power supply according to the present invention is that, by displacing the primary contact pin, said primary contact pin can be moved to an extremely space-saving position of rest. In addition, the plug-in power supply according to the present invention has a smooth surface, without any projecting plug pins which may get caught up with other components during transport, when the primary contact pin is at its position of rest. By arranging the primary contact pin at right angles to a lateral surface of the plug-in power supply in the operating position, it is additionally possible to prevent neighboring sockets from being rendered inaccessible.

In order to make the plug-in power supply compatible with existing mains sockets, same is provided with two primary contact pins, which, when occupying the operating position, are arranged at a distance from one another that conforms to the standard.

Further developments of the present invention are the subject matters of a plurality of dependent claims.

According to a preferred embodiment, the primary contact pins are adapted to be swiveled, e. g. for the purpose of transport, from the operating position, in which they are adapted to be inserted into the mains socket, to a position of rest on at least one of the lateral surfaces of the housing. This offers the advantage that no space for the contact pin is required in the interior of the housing. The structural design of the housing is particularly simple in the case of this embodiment.

According to another preferred embodiment, one of the primary contact pins is adapted to be axially displaced from the operating position to the position of rest on one of the lateral surfaces of the housing and the other primary contact pin is adapted to be swiveled from the operating position to the position of rest on one of the lateral surfaces of the housing. This embodiment offers the possibility of a particularly far-reaching miniaturization of the plug-in power supply, when the primary contact pins are at their position of rest and handling will be particularly easy.

In order to guarantee the highest possible safety of the plug-in power supply according to the present invention, the plug-in power supply can be so conceived that the electric connection between the primary contact pin and the electronic circuit in the interior of the housing will not be established until the final operating position has been reached.

Particularly safe contacting of the mains socket will be achieved when the primary contact pin is adapted to be locked in its operating position.

According to a preferred embodiment, the housing is provided with recesses which accommodate the primary contact pin in its position of rest. This will guarantee that the surface of the plug-in power supply according to the present invention is flat and that projecting pins which may get caught up with other components are avoided.

When the primary contact pin is so conceived that it is adapted to be locked in its position of rest, this will have the advantage that it is protected against inadvertent displacement from its position of rest.

According to a preferred embodiment, the housing of the plug-in power supply according to the present invention comprises two halves which are adapted to be connected to one another. This offers the advantage of a simplified, economy-priced assembly.

In order to guarantee an increased degree of safety, the plug-in power supply according to the present invention can be equipped with a mechanical coupling device which is provided between the two primary contact pins and which forces the two pins to move simultaneously.

A particularly simple and economy-priced possibility of realizing such a coupling device is the use of gears.

The housing can be provided with an electric connecting line which is adapted to be inserted via a plug into a plug socket of a load so that, when the plug-in power supply is in operation, a connected load can be arranged remote from the power socket (e.g. a mobile phone on a table).

### BRIEF DESCRIPTION OF THE DRAWINGS

The accompanying drawings are incorporated into and form a part of the specification for the purpose of explaining the principles of the invention. The drawings are not to be construed as limiting the invention to only the illustrated and described examples of how the invention can be made and used. Further features and advantages will become apparent from the following and more particular description of the invention, as illustrated in the accompanying drawings, wherein:

FIG. 1 illustrates a perspective view of a plug-in power supply according to the prior art;

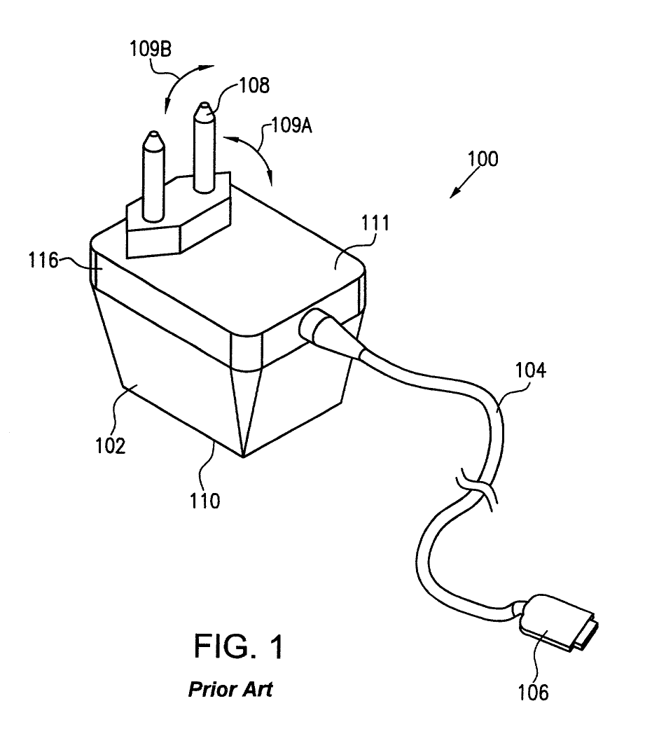

FIG. 2 illustrates various views of a plug-in power supply according to a preferred embodiment;

FIG. 3 illustrates various views of a plug-in power supply according to a second preferred embodiment;

FIG. 4 illustrates various views of a plug-in power supply according to a third preferred embodiment;

FIG. 5 illustrates two views of a plug-in power supply according to a fourth preferred embodiment.

### DETAILED DESCRIPTION OF THE INVENTION

The illustrative embodiments of the present invention will be described with reference to the figure drawings wherein like elements and structures are indicated by like reference numbers.

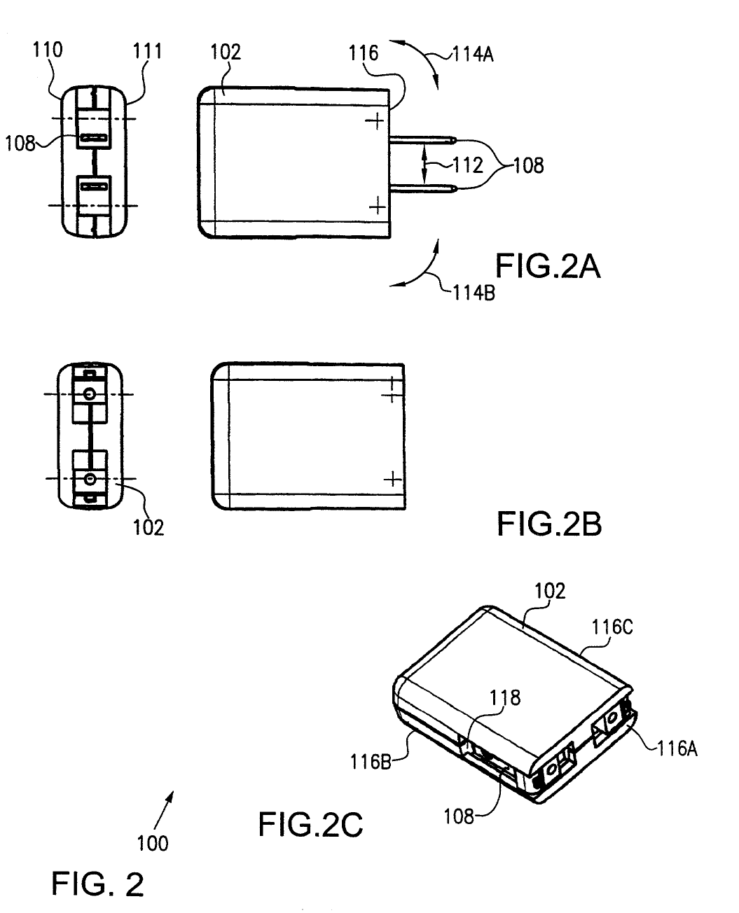

As can be seen in FIG. 2, the plug-in power supply 100 according to one embodiment comprises a housing 102 having arranged therein an electronic circuit for voltage conversion, an electric connecting line (not shown here so as to simplify the representations) which is adapted to be inserted via a plug into a plug socket of a load, and two primary contact pins 108 which are adapted to be inserted into a mains socket. In FIG. 2A the operating position of the plug-in power supply according to the present invention is shown. The two primary contact pins 108 protrude at right angles to a lateral surface 116 of the housing 102 and can be inserted into a mains socket in this position. The two primary contact pins 108 extend at a distance 112 from one another. This distance 112 as well as the implementation of the primary contact pins depend on the structural design of the mains socket into which the plug-in power supply is to be inserted. The primary contact pins may, for example, have a round as well as a rectangular cross-section. In the case of the embodiment outlined in the drawing, it is additionally guaranteed that, in a connector strip having arranged therein a plurality of mains sockets, neighboring sockets will not be covered. The primary contact pins 108 can, e.g. for the purpose of transport, be moved in directions 114A and 114B and assume a rest position on one of the lateral surfaces 116 of the housing 102. They are then located at the position of rest outlined in FIG. 2B. As can be seen from the perspective view in FIG. 2C, each of the housing sides 116B and 116C has provided therein a recess 118 which accommodates the respective primary contact pin 108. Due to the fact that the primary contact pins 108 can be embedded in the recesses 118, a completely flat surface of the plug-in power supply 100 is achieved at the position of rest, said surface of the plug-in power supply having no projections which may get caught up with other objects. In addition, the primary contact pins 108 are so conceived that, at the position of rest, which is shown in FIGS. 2B and 2C, they are not in electric contact with the electronic circuit for voltage conversion in the interior of the housing. This contact is not established until the operating position has fully been reached (cf. FIG. 2A).

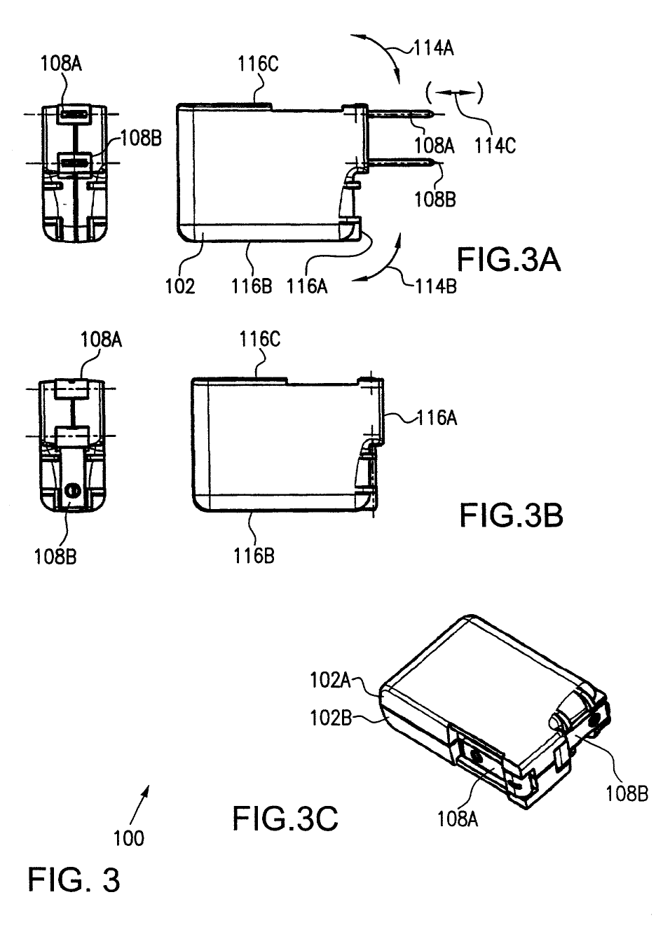

A second preferred embodiment of the plug-in power supply according to the present invention is shown in FIG. 3. FIG. 3A shows the primary contact pins 108 at the operating position, FIGS. 3B and 3C show the primary contact pins 108 at their position of rest. In this embodiment, the primary contact pins 108, when occupying the operating position, protrude eccentrically from the lateral surface 116A and are adapted to be moved onto the two different lateral surfaces 116A and 116C for the position of rest. The primary contact pin 108A can here either be implemented such that it is adapted to be swivelled in direction 114A or it can be movable in direction 114C by axial displacement. The primary contact pin 108B is swivelled in direction 114B so as to assume the rest position on the housing 102. Recesses 118 are provided on the lateral surfaces 116A and 116C of the housing, said recesses accommodating the contact pins 108 when these pins are at their position of rest. From the perspective representation of the plug-in power supply 100 in FIG. 3C, it can additionally be seen that the housing 102 is composed of two halves 102A and 102B, which are joined after the insertion of the primary contact pins 108 when the plug-in power supply is being assembled.

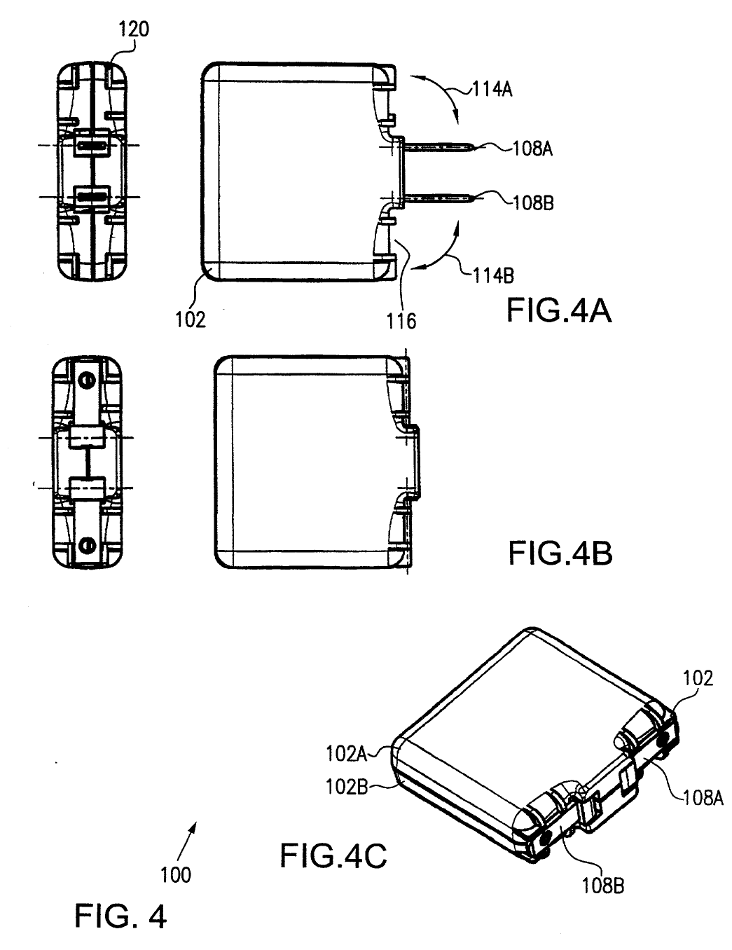

A third preferred embodiment of the plug-in power supply 100 according to the present invention is shown in FIG. 4. FIG. 4A shows two views of the plug-in power supply 100 in the operating position, whereas the views of FIGS. 4B and 4C show the rest position of the primary contact pins. In this embodiment, the primary contact pins 108A and 108B are arranged centrally on the lateral surface 116 of the housing. By swiveling the primary contact pins 108 in directions 114A and 114B, said pins are moved to the position of rest on the lateral surface 116. Projections 120 on both housing halves 102A and 102B define a reception means 118, which accommodates the contact pins 108A and 108B and which prevents them from getting caught up with an object during transport.

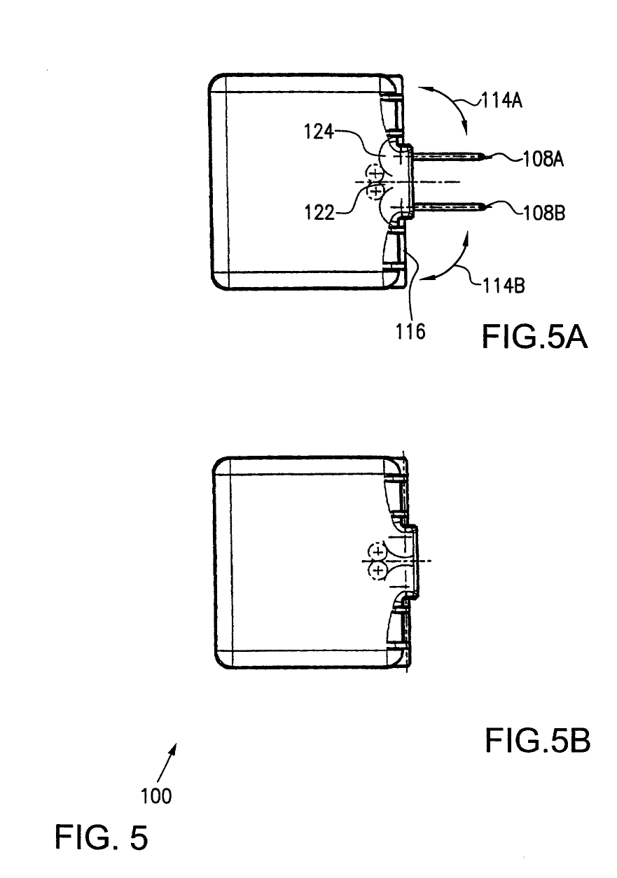

In the case of the geometric arrangement of the primary contact pins 108A and 108B shown in FIG. 5, a mechanical coupling 122 is provided between the primary contact pins 108A and 108B, which guarantees that the two primary contact pins can only be moved simultaneously in directions 114A and 114B. The mechanical coupling 122 is preferably realized through gears 124. By means of such forced control, it is guaranteed that the plug-in power supply 100 according to the present invention can only be inserted in the mains socket in an operating position conforming to the standard. It goes without saying that such a coupling can also be used in the embodiments outlined wit reference to FIGS. 2 and 3.

While the invention has been described with respect to the physical embodiments constructed in accordance therewith, it will be apparent to those skilled in the art that various modifications, variations and improvements of the present invention may be made in the light of the above teachings and within the purview of the appended claims without departing from the spirit and intended scope of the invention. In addition, those areas in which it is believed that those of ordinary skill in the art are familiar, have not been described therein in order to not unnecessarily obscure the invention described therein. Accordingly, it is to be understood that the invention is not to be limited by the specific illustrative embodiments, but only by the scope of the appended claims.

What is claimed is:

1. A plug-in power supply for converting a mains voltage into an operating voltage, comprising a housing having arranged therein an electronic circuit for voltage conversion, and at least two primary contact pins which are movable between an operating position, in which they are adapted to be inserted into the mains socket and in which they extend substantially at right angles to one of the lateral surfaces of the housing, and a position of rest on at least one of said lateral surfaces, the primary contact pins being arranged substantially parallel to said at least one lateral surface in said position of rest,
characterized in that
a geometric arrangement of the primary contact pins with respect to each other in their position of rest differs from a geometric arrangement of the primary contact pins in their operating position.

2. A plug-in power supply according to claim 1, characterized in that the primary contact pins are adapted to be swiveled from the operating position to the position of rest on at least one of the lateral surfaces of the housing.

3. A plug-in power supply according to claim 1, characterized in that one of the two primary contact pins is adapted to be axially displaced from the operating position to the position of rest on one of the lateral surfaces of the housing and that the other primary contact pin is adapted to be swiveled from the operating position to the position of rest on one of the lateral surfaces of the housing.

4. A plug-in power supply according to claim 1, characterized in that the electronic circuit in the interior of the housing is provided with electric contacts for connection to the primary contact pins, said electric contacts being arranged such that the electric connection is not established until the final operating position has been reached.

5. A plug-in power supply according to claim 1, characterized in that the primary contact pins are adapted to be locked in their operating position.

6. A plug-in power supply according to claim 1, characterized in that the housing is provided with reception means which accommodate the primary contact pins in their position of rest.

7. A plug-in power supply according to claim 1, characterized in that the primary contact pins are adapted to be locked in their position of rest.

8. A plug-in power supply according to claim 1, characterized in that the housing comprises two halves which are adapted to be connected to one another.

9. A plug-in power supply according to claim 1, characterized in that a mechanical coupling device provided between the two primary contact pins forces the two pins to move simultaneously.

10. A plug-in power supply according to claim 9, characterized in that the mechanical coupling is effected through gears.

11. A plug-in power supply according to claim 1, characterized in that the housing is provided with an electric connecting line which is adapted to be inserted via a plug into a plug socket of a load.
